(19) United States
(12) Patent Application Publication
(10) Pub. No.: US 2021/0124238 A1
(43) Pub. Date: Apr. 29, 2021

(54) DRIVING APPARATUS AND OPTICAL APPARATUS

(71) Applicant: CANON KABUSHIKI KAISHA, Tokyo (JP)

(72) Inventor: Shunsuke Ninomiya, Kanagawa (JP)

(21) Appl. No.: 17/080,371

(22) Filed: Oct. 26, 2020

(30) Foreign Application Priority Data
Oct. 29, 2019 (JP) 2019-195834

(51) Int. Cl. G03B 5/02; H02N 2/02; G02B 7/04; H02N 2/00

(52) U.S. Cl. CPC G03B 5/02; H02N 2/026; G03B 2205/0084; H02N 2/001; G02B 7/04

(57) ABSTRACT

In a driving apparatus, a movable part is attached to a fixed part so that the movable part is restricted from displacing in a second axial direction and from rotating in a first rotating direction, and the movable part is allowed to move in a first axial direction, to displace in a third axial direction, and to rotate in a second rotating direction. The movable part is connected to a driven member movable in the first axial direction so that the movable part is allowed to displace in the second axial direction and to rotate in the first rotating direction, and restricted from displacing in the third axial direction and from rotating in the second rotating direction.

### BACKGROUND OF THE INVENTION

### Field of the Invention

The present invention relates to a driving apparatus (vibration type motor) for linear driving.

### Description of the Related Art

Japanese Patent No. 6122452 discloses a vibration type driving apparatus for linear driving, which includes a vibrator having a piezoelectric element and an elastic member, a friction member in contact with the vibrator, a pressing member that presses the vibrator against the friction member, and a guide member that receives a pressure reaction force of the pressing member and linearly guides a movement of the vibrator. In the vibration type driving apparatus disclosed in Japanese Patent No. 6122452, two ball members each serving as the guide member are arranged side by side in the moving direction of the vibrator, and roll in a V groove portion that is formed in each of a movable part that holds the vibrator and a fixed part that holds the friction member and extends in the moving direction so that the movable part is smoothly guided in the moving direction.

However, the vibration type driving apparatus disclosed in Japanese Patent No. 6122452 needs a longer length for the V groove portion, as a moving length of the movable part increases. As a result, the movable part provided with the V groove portion becomes larger in the moving direction, and thereby the vibration type driving apparatus becomes larger.

### SUMMARY OF THE INVENTION

The present invention provides a vibration type driving apparatus that can increase a moving length of a movable part without increasing the size of the movable part.

A driving apparatus according to one aspect of the present invention includes a vibrator, a friction member that compressively contacts the vibrator, a movable part that holds one of the vibrator and the friction member, and a fixed part that holds the other of the vibrator and the friction member, the movable part moving relative to the fixed part when the vibrator vibrates. Where a first axial direction is a direction in which the movable part moves relative to the fixed part due to a vibration of the vibrator, a second axial direction is a direction in which the vibrator is pressed against the friction member, a third axial direction is a direction orthogonal to the first and second axial directions, a first rotating direction is a rotating direction around an axis extending in the first axial direction, and a second rotating direction is a rotating direction around an axis extending in the second axial direction, the movable part is attached to the fixed part so that the movable part is restricted from displacing in the second axial direction and from rotating in the first rotating direction, and the movable part is allowed to move in the first axial direction, to displace in the third axial direction, and to rotate in the second rotating direction. The movable part is connected to a driven member movable in the first axial direction so that the movable part is allowed to displace in the second axial direction and to rotate in the first rotating direction, and restricted from displacing in the third axial direction and from rotating in the second rotating direction.

A driving apparatus according to another aspect of the present invention includes a vibrator, a friction member that compressively contacts the vibrator, a movable part that holds one of the vibrator and the friction member, and a fixed part that holds the other of the vibrator and the friction member, the movable part moving relative to the fixed part when the vibrator vibrates. Where a first axial direction is a direction in which the movable part moves relative to the fixed part due to a vibration of the vibrator, a second axial direction is a direction in which the vibrator is pressed against the friction member, and a third axial direction is a direction orthogonal to the first and second axial directions, the movable part includes a rotating member that moves in the first axial direction integrally with the movable part while rolling in contact with the fixed part. There are at least two rotating members on both sides of the friction member in the third axial direction. A contact surface of the fixed part which the rotating member contacts and rolls on is provided within a range in which the friction member is provided in the second axial direction.

An optical apparatus including the above driving apparatus also constitutes another aspect of the present invention.

Further features of the present invention will become apparent from the following description of exemplary embodiments with reference to the attached drawings.

### BRIEF DESCRIPTION OF THE DRAWINGS

FIGS. 1A to 1C illustrate a configuration of a vibration type motor according to a first embodiment of the present invention.

FIG. 2 illustrates a configuration of a lens driving apparatus according to the first embodiment.

FIGS. 3A to 3C illustrate a configuration of a connector according to the first embodiment.

FIGS. 4A to 4D illustrate a connection state between the vibration type motor according to the first embodiment and the connector.

FIGS. 5A and 5B illustrate a variation according to the first embodiment.

FIGS. 6A to 6C illustrate a configuration of the conventional vibration type motor.

FIGS. 7A and 7B illustrate an effect of the vibration type motor according to the first embodiment.

FIGS. 8A and 8B illustrate a configuration of a vibration type motor according to a second embodiment of the present invention.

FIGS. 9A to 9C illustrate a configuration of a rolling mechanism in the vibration type motor according to the second embodiment.

### DESCRIPTION OF THE EMBODIMENTS

Referring now to the accompanying drawings, a description will be given of embodiments according to the present invention. In the following description, a relative moving direction between a vibrator and a friction member, which will be described later, is set to an X direction, and a pressing direction for pressing the vibrator against the friction member is set to a Z direction. In the Z direction, a direction from the friction member to the vibrator is set to a +Z direction, and a direction from the vibrator to the friction member is set to a −Z direction. A direction orthogonal to the X direction and the Z direction is set to a Y direction. The relative moving direction (X direction), the pressing direction (Z direction), and the direction (Y direction) orthogonal to them correspond to a first axial direction, a second axial direction, and a third axial direction, respectively. A rotating direction around an X axis extending in the X direction is a roll direction, a rotating direction around a Z axis extending in the Z direction is a yaw direction, and a rotating direction around a Y axis extending in the Y direction is a pitch direction. The roll direction, the yaw direction, and the pitch direction correspond to the first rotating direction, the second rotating direction, and the third rotating direction, respectively.

### First Embodiment

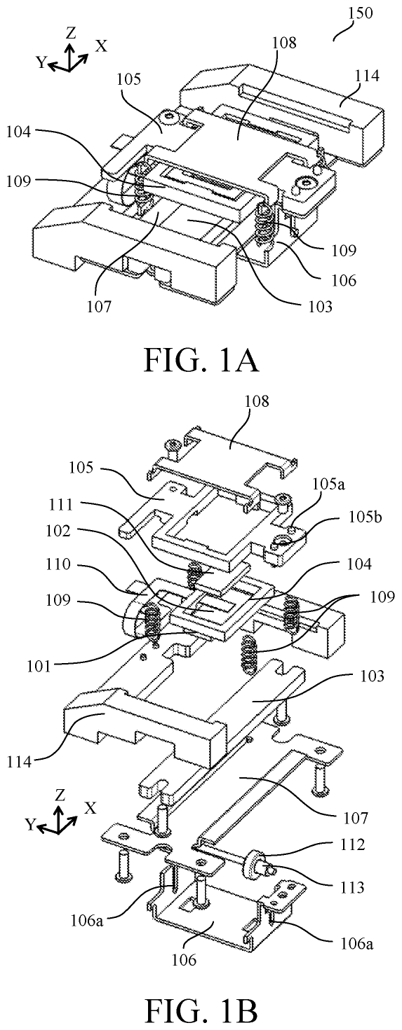

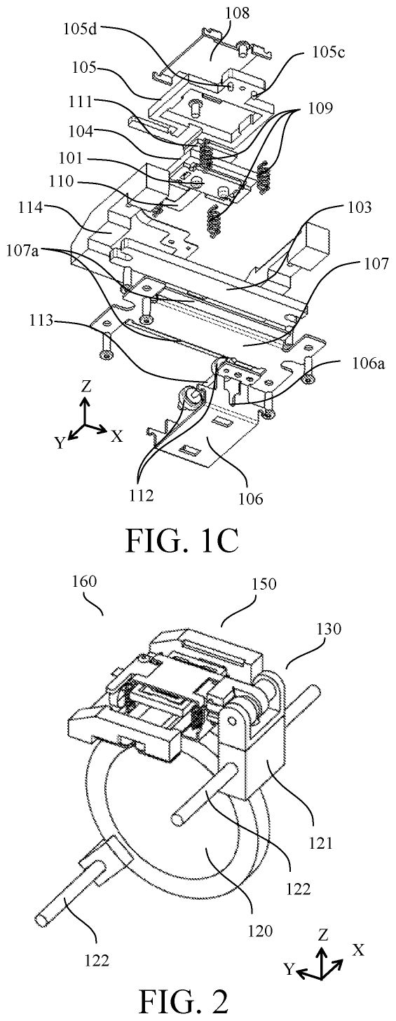

FIGS. 1A to 1C illustrate a configuration of a vibration type motor 150 as a vibration type driving apparatus according to a first embodiment of the present invention. FIG. 1A illustrates an assembled state of the vibration type motor 150, and FIGS. 1B and 1C illustrate the vibration type motor 150 in a disassembled state viewed from the −Z direction and the +Z direction, respectively.

The vibrator 100 includes a vibration plate 101 as an elastic member having two protrusion portions, and a piezoelectric element 102 that vibrates when a frequency voltage is applied through a flexible printed circuit board 110. The piezoelectric element 102 is fixed to the vibration plate 101 by adhesive agent or the like, and the vibration of the piezoelectric element 102 excites the vibration of the vibration plate 101. The vibration plate 101 has two protrusion portions, and the vibrations excited by the vibration plate 101 cause elliptical motions in the respective protrusion portions.

A friction member 103 is a contact member that contacts the vibrator 100, and is fixed to a base member 114 that holds the friction member 103 with a screw. When the protrusion portion of the vibration plate 101 compressively contacts the friction member 103 by the biasing force of four pressing members 109 described later, the friction between the friction member 103 and the protrusion portion which makes the elliptical motion causes the vibrator 100 and the friction member 103 to relatively move in the X direction. In this embodiment, the vibrator 100 moves relative to the fixed friction member 103.

The holding member 104 holds the vibrator 100 by fixing it with adhesive or screws. The movable member 105 holds the holding member 104, and the movable member 105 and the holding member 104 move integrally in the X direction. In other words, the vibrator 100, the holding member 104, and the movable member 105 move integrally with the friction member 103. The movable member 105 and a movable sheet metal 106 described later constitute a movable part that holds the vibrator 100 via the holding member 104, and the fixed part includes a base member 114 that holds the friction member 103 and a fixed sheet metal 107 that will be described later.

During the assembly of the vibration type motor 150, the holding member 104 and the movable member 105 are displaceable in the Z direction relative to the fixed part. Thereby, even if there are variations in parts or assembly errors, the vibrator 100 held by the holding member 104 is displaced in the Z direction relative to the friction member 103 held by the fixed part, and stably contacts the friction member 103.

Each of the four pressing members 109 includes a tension spring, and presses the vibrator 100 against the friction member 103 by its biasing force (pressing force). The pressing force from the pressing member 109 acts on a pressure plate 108 and a movable metal plate 106, and is applied to the vibrator 100 from the pressure plate 108 via a buffer member 111. The buffer member 111 provided between the pressure plate 108 and the vibrator 100 can prevent the vibration of the vibrator 100 from being attenuated due to the pressure plate 108 directly contacting the vibrator 100.

The movable sheet metal 106 is fixed to the movable member 105 with a screw and moves integrally with the movable member 105. The fixed sheet metal 107 is fixed to the base member 114 with a screw. The movable sheet metal 106 is biased against the fixed sheet metal 107 by the biasing force of the pressing member 109.

A shaft 113 is engaged with and fixed to two rotating members 112 that move integrally with the movable member 105 in the X direction. The rotating member 112 has a bearing. The shaft 113 is rotatably supported by a U-shaped shaft receiver 106a provided on the movable sheet metal 106. The rotating member 112 fixed to the shaft 113 is sandwiched between the movable metal plate 106 and the fixed metal plate 107. The rotating member 112 contacts a rolling surface 107a of the fixed metal plate 107. The two rotating members 112 are provided on both sides of the friction member 103 in the Y direction. When the movable sheet metal 106 moves in the X direction, the rotating member (rotator of bearing) 112 rolls on the rolling surface 107a. Thereby, the movable sheet metal 106 can smoothly move without sliding on the fixed sheet metal 107 (or with a low moving load).

The rotating member 112 may be a member other than the bearing as long as it can reduce the moving load by rotating the movable plate 106 with the movement of the movable plate 106 relative to the fixed plate 107 in the X direction.

Referring now to FIG. 2, a description will be given of a configuration of the lens driving apparatus 160 including the vibration type motor 150 described above. The lens driving apparatus 160 is mounted on an optical apparatus such as an interchangeable lens apparatus or a lens integrated image pickup apparatus.

The vibration type motor 150 is fixed to an unillustrated member with a screw or the like. A lens 120 is held by a lens holding member 121 as a driven member. The lens holding member 121 is engaged with the two guide bars 122 and linearly guided in the optical axis direction as the X direction. A connector 130 is fixed to the lens holding member 121 with a screw or the like. The lens holding member 121 is connected to the movable member 105 via the connector 130, whereby the lens holding member 121 and the movable member 105 integrally move in the optical axis direction. In the vibration type motor 150, the vibrator 100 vibrates and the movable part including the movable member 105 moves relative to the fixed part, whereby the lens holding member 121 (or the lens 120) can be moved in the optical axis direction.

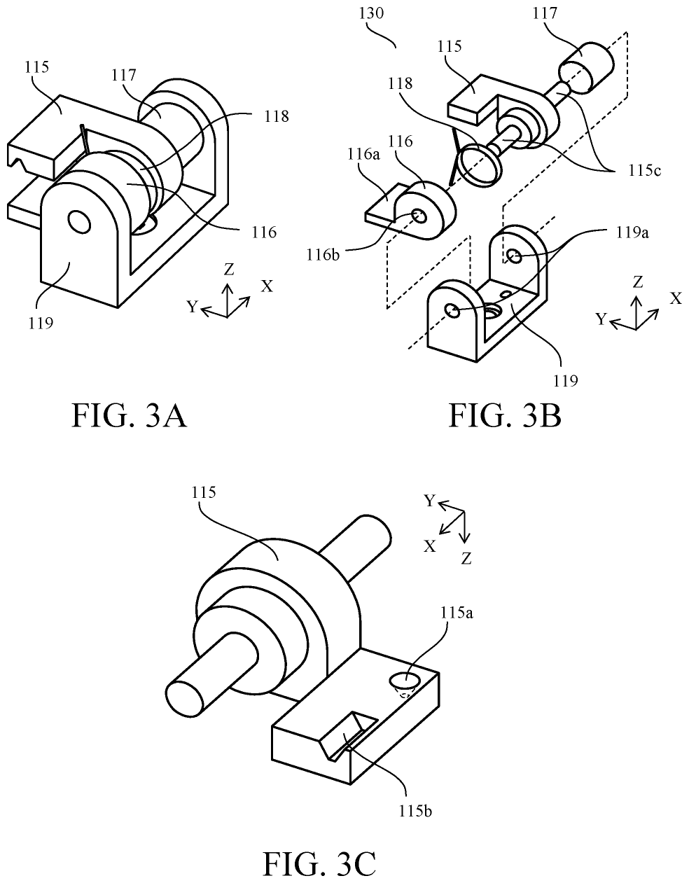

Referring now to FIGS. 3A to 3C, a description will be given of a configuration of the connector 130. FIG. 3A illustrate an assembled state of the connector 130, and FIG. 3B illustrates the connector 130 in an exploded state. FIG. 3C illustrates a configuration of a first rack member 115 in the connector 130.

The connector 130 has the first rack member 115, a second rack member 116, a compression biasing spring 117, a rotation biasing spring 118, and a connecting member 119. An engagement shaft portion 115c provided on the first rack member 115 is rotatably engaged with an engagement hole portion 116b provided in the second rack member 116. The engagement shaft portion 115c of the first rack member 115 is also rotatably engaged with an engagement hole portion 119a in the connecting member 119, and thereby the first rack member 115 and the second rack member 116 are rotatably supported by the connecting member 119.

The compression biasing spring 117 biases the first rack member 115 and the second rack member 116 in one X direction against the connecting member 119. Thereby, there is no looseness (play) in the X direction among the first rack member 115, the second rack member 116, and the connecting member 119, and they can integrally move in the X direction.

The two arms 118a of the rotation biasing spring 118 contact the first rack member 115 and the second rack member 116, respectively, and apply forces opposite to each other to the first rack member 115 and the second rack member 116 in the rotating direction around the engagement shaft portion 115c. As illustrated in FIG. 1B, the first rack member 115 has a conical hole portion 115a that is engaged with ball projections 105a and 105b provided side by side in the X direction on the surface of the movable member 105 facing the −Z direction, and a V groove portion 115b that extends in the X direction. The second rack member 116 has a contact surface 116a that contacts ball projections 105c and 105d provided side by side in the X direction on the surface of the movable member 105 facing the +Z direction.

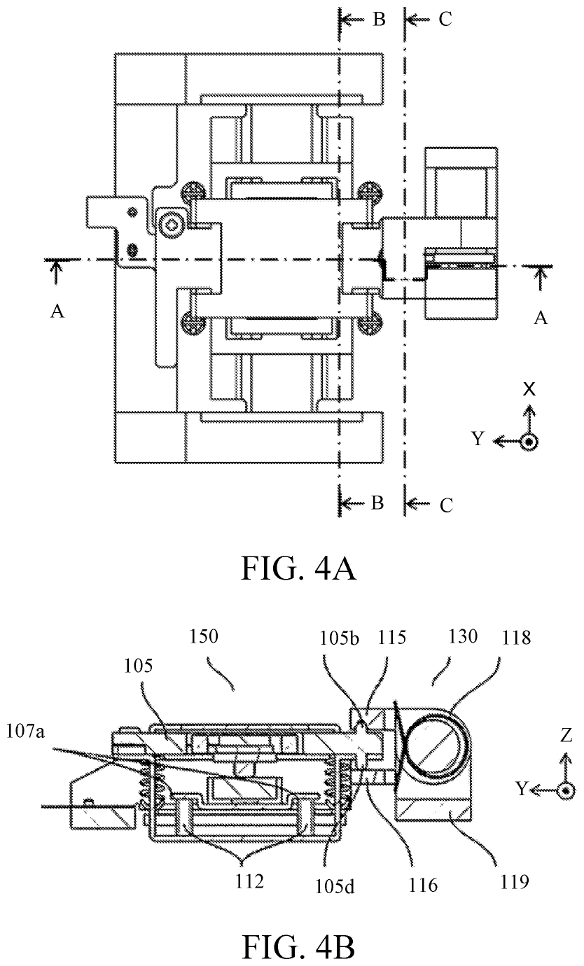

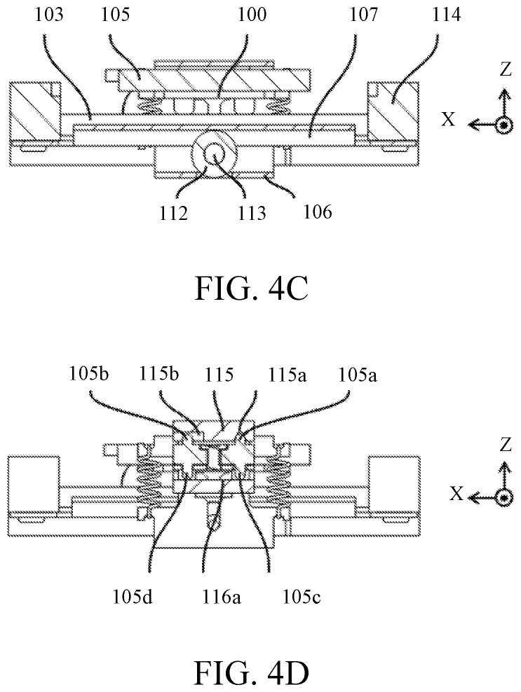

FIGS. 4A to 4D illustrate a connection state of the vibration type motor 150 and the connector 130. FIG. 4A illustrates the vibration type motor 150 and the connector 130 viewed from the Z direction, and FIG. 4B illustrates a section (YZ section) taken along a line A-A in FIG. 4A viewed from the X direction. FIG. 4C illustrates a section (XZ section) taken along a line B-B in FIG. 4A viewed from the Y direction, and FIG. 4D illustrates a section (XZ section) taken along a line C-C in FIG. 4A viewed from the Y direction.

As described above, the ball protrusions 105a and 105b of the movable member 105 are engaged with the conical hole portion 115a and the V groove portion 115b in the first rack member 115, respectively, and the ball protrusions 105c and 105d of the movable member 105 contact the contact surface 116a of the second rack member 116. As described above, the first rack member 115 and the second rack member 116 receive the biasing force in the rotating direction around the engagement shaft portion 115c from the rotation biasing spring 118. Due to the biasing force in the rotation direction, the first rack member 115 and the second rack member 116 sandwich the movable member 105, so that the vibration motor 150 and the connector 130 are connected.

Since the conical hole portion 115a in the first rack member 115 is engaged with the ball projection 105a of the movable member 105 while being biased against the ball projection 105a, the first rack member 115 and the movable member 105 can steadily and integrally move in the X direction. As described above, since the first rack member 115 and the connecting member 119 can integrally move in the X direction, the movable member 105 and the connecting member 119 can also integrally move in the X direction. Since the connecting member 119 is fixed to the lens holding member 121, the driving force for driving the movable part in the vibration type motor 150 can be transmitted to the lens holding member 121 without play by connecting the movable member 105 to the lens holding member 121 via the connector 130.

The conical hole portion 115a, the V groove portion 115b, and the ball protrusions 105a to 105d each correspond to engagement part.

Next follows a description of whether or not the movable member 105 (or the movable part) is to move or displace relative to the fixed sheet metal 107 (or the fixed part). As described above, the movable member 105 is fixed to the movable metal plate 106, and the two rotating members 112 fixed to the shaft 113 supported by the movable metal plate 106 contact the fixed metal plate 107. Since the rotating member 112 rolls on the rolling surface 107a on the fixed sheet metal 107, the movable member 105 can move in the X direction relative to the fixed sheet metal 107.

Since the two rotating members 112 aligned with the Y direction contact the fixed metal plate 107, the movable member 105 moving integrally with the rotating member 112 relative to the fixed metal plate 107 is restricted (blocked) from displacing (rotating) in the rolling direction.

In FIG. 4C, since the rotating member 112 is provided only at one location in the X direction, the movable member 105 can rotate around the shaft 113 relative to the fixed sheet metal 107. In other words, the movable member 105 is allowed to displace (rotate) in the pitch direction relative to the fixed sheet metal 107.

Since the rolling surface 107a of the fixed sheet metal 107 which the two rotating members 112 contact is a flat surface, the rotating member 112 and the shaft 113 can displace in the Y direction relative to the fixed sheet metal 107, and rotate in the yaw direction. In other words, the movable member 105 is allowed to displace in the Y direction and the yaw direction relative to the fixed sheet metal 107.

The position of the movable member 105 in the Z direction is determined by the rotating member 112 contacting the rolling surface 107a and the fixed sheet metal 107. This structure restricts the movable member 105 from displacing in the Z direction relative to the fixed sheet metal 107 after the assembly of the vibration type motor 150 is completed.

As described above, the movable part is attached to the fixed part so that the movable part is allowed to move, displace, and rotate in the X direction (first axial direction), the Y direction (third axial direction), the yaw direction (second rotating direction), and the pitch direction (third axial direction), and is restricted from displacing and rotating in the Z direction (second axial direction) and the rolling direction (first rotation direction).

Next follows a description of whether or not a relative displacement between the movable member 105 and the lens holding member 121 is to be allowed. The connector 130 is fixed to the lens holding member 121, and they integrally move in the X direction. Therefore, the following will discuss whether or not the relative displacement between the movable member 105 and the connector 130 is to be allowed.

As described above, since the conical hole portion 115a of the first rack member 115 and the ball projection 105a of the movable member 105 are engaged with each other, the relative displacement in the X direction is restricted between the movable member 105 and the connector 130. In addition to the engagement between the conical hole portion 115a and the ball protrusion 105a, the ball protrusion 105b of the movable member 105 is engaged with the V groove 115b extending in the X direction in the first rack member 115. Thus, both the relative displacement in the Y direction between the ball protrusion 105a and the conical hole portion 115a and the relative displacement in the Y direction between the ball protrusion 105b and the V groove 115b are restricted. In other words, the relative displacement in the Y direction is restricted between the movable member 105 and the connector 130.

As described above, the first rack member 115 has the conical hole portion 115a as one first restrictor that restricts the relative displacement in the X direction between the movable member 105 and the connector 130, and the lens holding member 121, and the conical hole portion 115a and the V groove portion 115b as two second restrictors that restrict the relative displacement in the Y direction between the movable member 105 and the connector 130, and the lens holding member 121. Since the first rack member 115 has the conical hole portion 115a and the V groove portion 115b aligned in the X direction, the relative displacement in the yaw direction is also restricted between the movable member 105 and the connector 130. The ball projections 105a and 105b of the movable member 105 are arranged in the X direction, and the ball projections 105c and 105d are also arranged in the X direction, and they are sandwiched by the conical hole portion 115a, the V groove portion 115b, and the contact surface 116a. Therefore, the relative displacement in the pitch direction is also restricted between the movable member 105 and the connector 130.

The first rack member 115 and the second rack member 116 are rotatable around the X axis (engagement shaft portion 115c) relative to the connecting member 119. Therefore, when the first rack member 115 and the second rack member 116 rotates relative to the connecting member 119, the relative displacement between the movable member 105 and the connector 130 is allowed in the Z direction and the roll direction.

As described above, the movable part is connected to the lens holding member 121 so that the movable part is restricted from displacing and rotating in the X direction (first axial direction), the Y direction (third axial direction), the yaw direction (second rotating direction), and the pitch direction (third rotating direction), and is allowed to displace and rotate in the Z direction (second axis direction) and the roll direction (first rotating direction).

In other words, the relative displacement between the movable member 105 and the lens holding member 121 is restricted in the X direction, the Y direction, the pitch direction, and the yaw direction in which the movable member 105 and the fixed sheet metal 107 can displace relative to each other. On the other hand, the relative displacement between the movable member 105 and the lens holding member 121 is allowed in the Z direction and the roll direction in which the relative displacement between the movable member 105 and the fixed sheet metal 107 is restricted.

The lens holding member 121 is linearly guided (or movable) in the X direction by the guide bar 122, and is restricted from displacing in the Y direction, the Z direction, the pitch direction, the yaw direction, and the roll direction other than the X direction. In other words, any one of the components interposed between the lens holding member 121 whose displacement in a direction other than the X direction is restricted and the fixed metal plate 107 is allowed to relatively displace in the Y direction, the Z direction, the pitch direction, and the yaw direction. Therefore, even if there is a processing error or an assembly error of each component, the lens holding member 121 can be smoothly driven (with a low load) in the X direction without play (looseness).

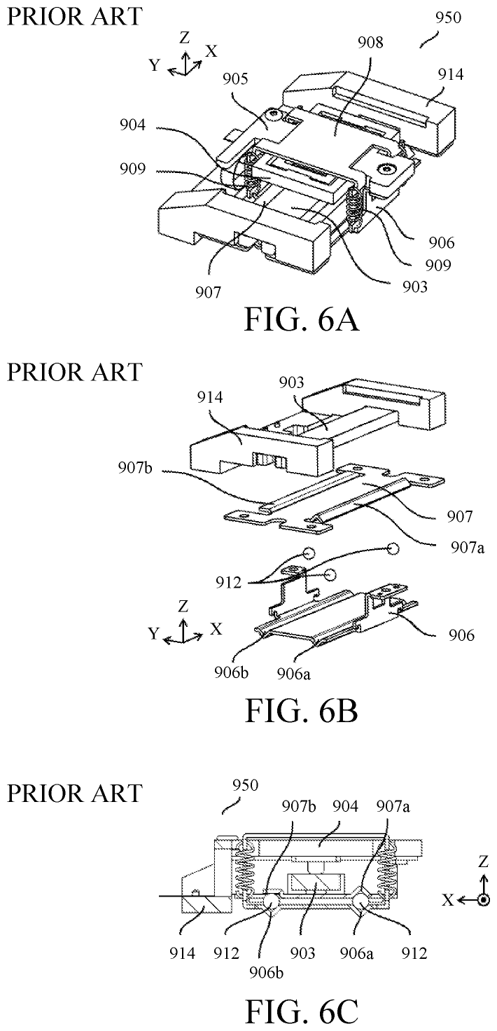

Referring now to FIGS. 6A to 6C, a description will be given of a configuration of a conventional vibration type motor 950. FIG. 6A illustrates an assembled state of the conventional vibration type motor 950, and FIG. 6B illustrates the vibration type motor 950 in an exploded state. However, FIG. 6B illustrates only a friction member 903, a movable metal plate 906, a fixed metal plate 907, rotating members 912, and a base member 914. FIG. 6C illustrates a YZ section of the vibration motor 950.

In the conventional vibration type motor 950, three rolling members (balls) 912 are arranged between the movable metal plate 906 and the fixed metal plate 907. Two of the three rolling members 912 are sandwiched between a V-shaped bent portion (V groove portion) 906a of the movable sheet metal 906 and a V-shaped bent portion 907a of the fixed sheet metal 907, and one of them is sandwiched between a V-shaped bent portion 906b of the movable sheet metal 906 and a flat portion 907b of the fixed metal plate 907. When the movable sheet metal 906 moves in the X direction relative to the fixed sheet metal 907, the three rolling members 912 roll between the movable sheet metal 906 and the fixed sheet metal 907. Thereby, the movable sheet metal 906 smoothly moves relative to the fixed sheet metal 907.

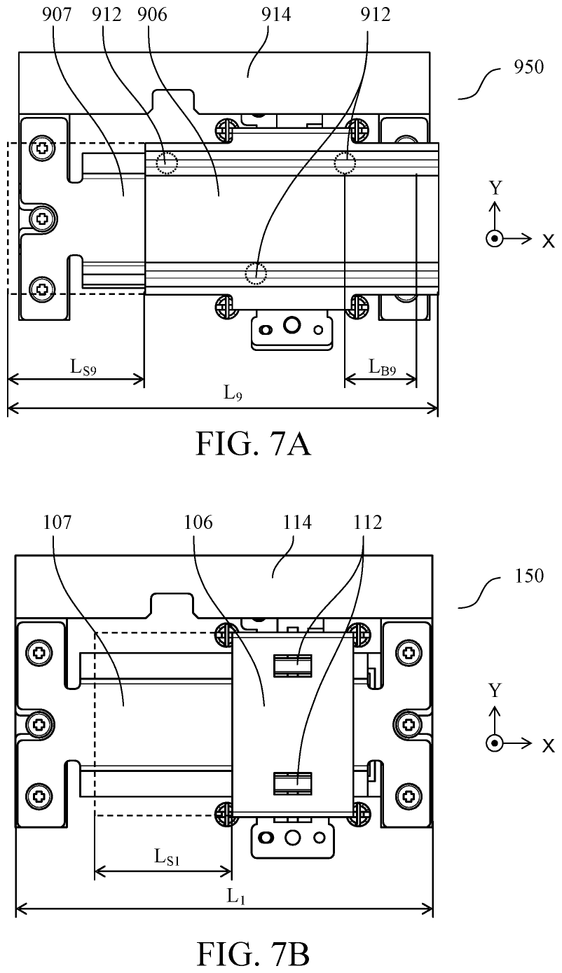

Referring now to FIGS. 7A and 7B, a description will be given of an effect obtained by the vibration type motor 150 according to this embodiment. FIG. 7A illustrates the conventional vibration type motor 950 illustrated in FIGS. 6A to 6C viewed from the +Z direction. FIG. 7B illustrates the vibration type motor 150 according to this embodiment viewed from the +Z direction.

In the conventional vibration type motor 950, when the rolling member 912 rolls between the movable sheet metal 906 and the fixed sheet metal 907 as the movable sheet metal 906 moves in the X direction, the relative position in the X direction changes between the movable sheet metal 906 and the rolling member 912. Hence, the movable sheet metal 906 needs to have at least a length in the X direction for the rolling member 912 to roll, and this rolling length L_{B9} is determined according to a moving length L_{S9} of the movable member 905. When the moving length L_{S9} of the movable member 905 is long, the rolling length L_{B9} is accordingly long, and consequently the size of the movable member 905 increases in the X direction. When the moving length L_{S9} is equal to or more than a certain length and the movable member 905 is located at the moving end, the movable sheet metal 906 protrudes from a base member 914 and the overall length L₉ of the vibration type motor 150 increases in the X direction. In other words, the vibration type motor 950 becomes large. As the moving length L_{S9} increases, the movable sheet metal 906 also becomes large and the weight increases.

On the other hand, in the vibration type motor 150 according to this embodiment, as the movable sheet metal 906 moves in the X direction, the rotating member 112 rolls on the fixed sheet metal 107 while moving integrally with the movable sheet metal 106. The dimension of the movable sheet metal 106 in the X direction is constant regardless of the moving length L_{S1}. Therefore, even when the movable member 105 is located at the moving end, the movable sheet metal 106 does not protrude from the base member 114, and the overall length L1 of the vibration type motor 150 does not become long in the X direction even if the moving length L_{S1} is long. Since the size of the movable sheet metal 106 does not change depending on the moving length L_{S1}, the weight of the movable sheet metal 106 does not increase.

Thus, the configuration in which the rolling rotating member 112 that moves integrally with the movable sheet metal 106 reduces the load when the movable sheet metal 106 moves relative to the fixed sheet metal 107, can avoid the dimension and weight of the movable part in the X direction from increasing and maintain long the moving length of the movable part in the X direction. In other words, the vibration type motor 150 can be avoided from becoming larger due to an increase in the size of the moving part as a result of increasing the moving length of the moving part.

In the description of the vibration type motor 150 according to the first embodiment described above, the ball protrusions 105a and 105b provided on the movable part (movable member 105) and the conical hole portion 115a and the V-shaped groove 115b provided on the connector 130 (first rack member 115) are engaged with each other. However, another configuration may be used as long as there are provided one first restrictor that restricts the relative displacement in the X direction between the movable part and the connector and two second restrictors that restrict the relative displacement in the Y direction between the movable part and the connector.

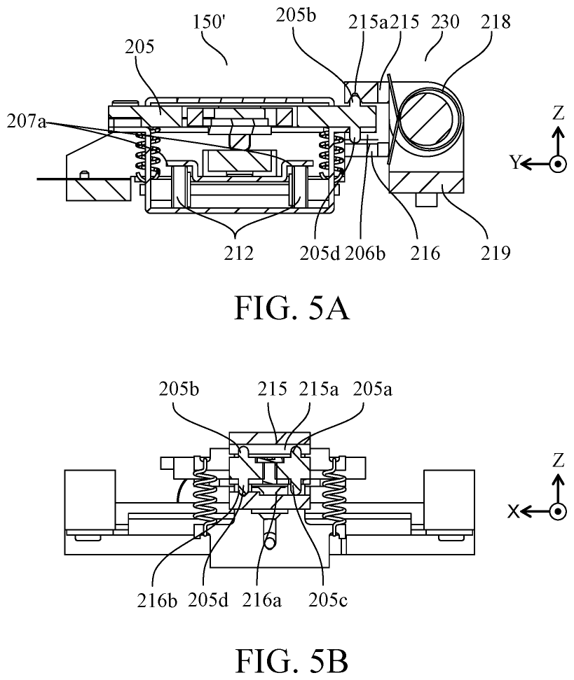

FIGS. 5A and 5B illustrate a configuration of a vibration type motor 150′ according to a variation of the first embodiment, and are diagrams corresponding to FIGS. 4B and 4D, respectively. Two ball protrusions 205a and 205b aligned with the X direction are provided on the surface of the movable member 205 facing the +Z direction, and these ball protrusions 205a and 205b are engaged with one V groove portion 215a that is provided on the first rack member 215 and is long in the X direction. The relative displacement in the Y direction between the movable member 205 and the connector 230 is restricted at two locations where the ball protrusions 205a and 205b are engaged with the V groove portion 215a.

Two spherical projections 205c and 205d aligned with in the X direction on the surface of the movable member 205 facing the −Z direction are respectively engaged with the V direction portion 216a that extends in the X direction and the conical hole portion 216b provided on the second rack member 216. The relative displacement in the X direction between the movable member 205 and the connector 230 is restricted at one location where the ball projection 205d is engaged with the conical hole portion 216b.

Thus, the vibration type motor 150′ according to this variation also includes at least one first restrictor that restricts the relative displacement in the X direction between the movable part and the connector, and at least two second restrictors that restrict the relative displacement in the Y direction between the movable part and the connector, and whether the relative displacement in each direction between the movable member 205 and the connector 230 is to be allowed is similar to that of the vibration type motor 150 according to the first embodiment. Therefore, even in the vibration type motor 150′ according to this variation, the movable part can be smoothly driven without causing any loads due to the processing error or assembly error of the components.

### Second Embodiment

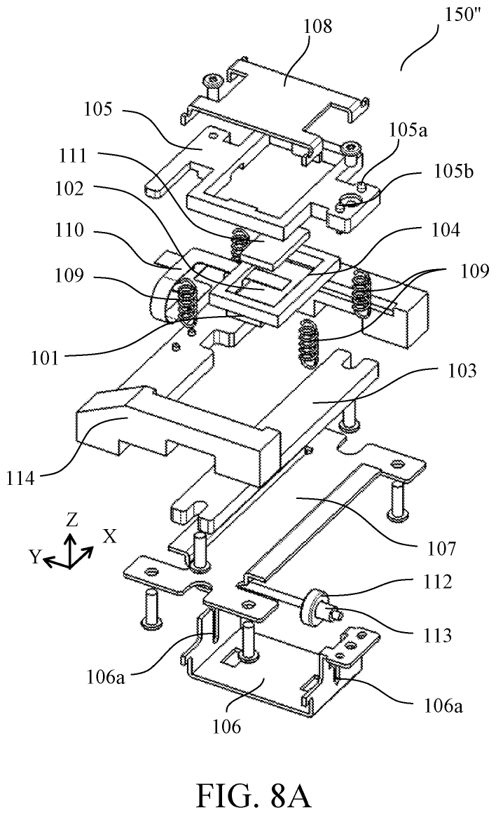

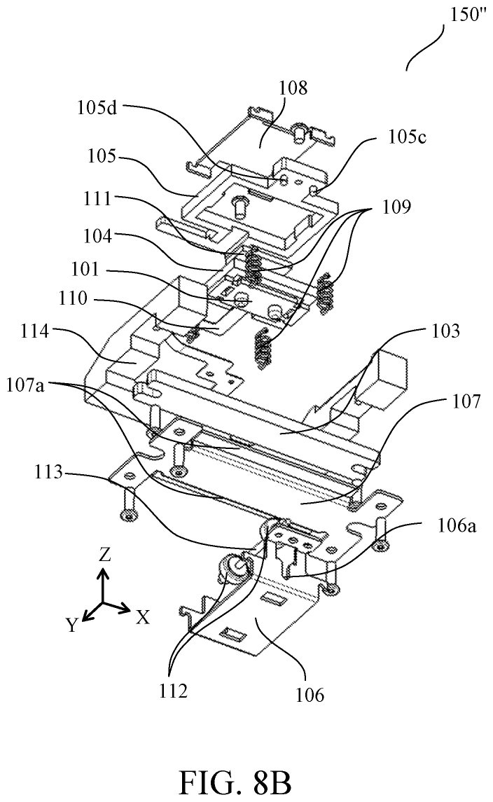

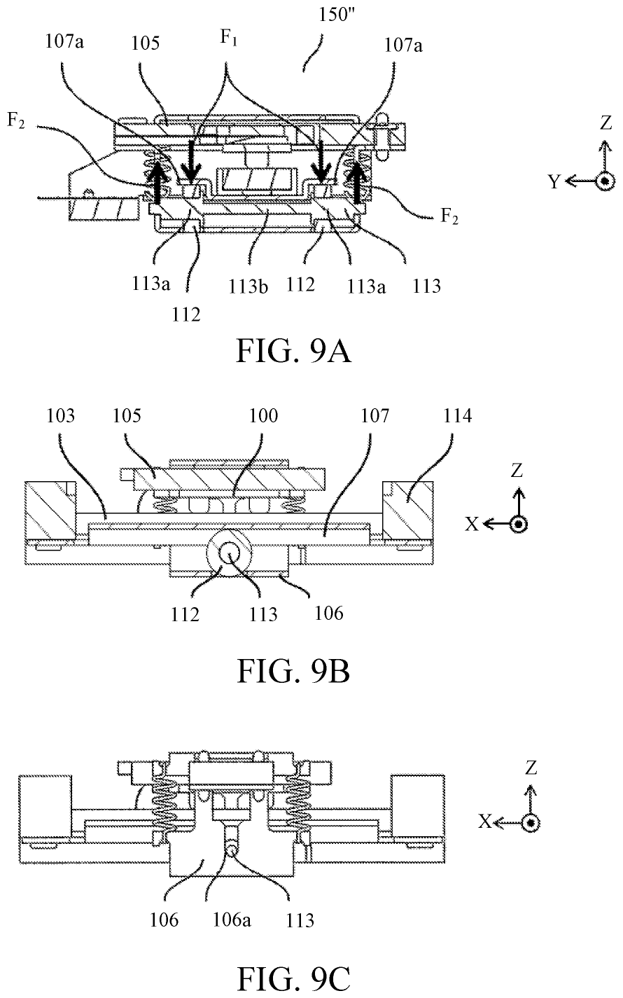

FIGS. 8A and 8B are exploded views of the vibration type motor 150″ according to a second embodiment of the present invention, which are viewed from the −Z direction and the +Z direction. FIG. 9A illustrates a YZ section (corresponding to a section taken along a line A-A in FIG. 4A) of the vibration type motor 150″ in the assembled state, and FIG. 9B illustrates a XZ section (corresponding to a section taken along a line B-B in FIG. 4A) of the vibration motor 150″. FIG. 9C illustrates another XZ section (corresponding to a section taken along the line C-C in FIG. 4A) of the vibration type motor 150″.

Since the basic configuration of the vibration type motor 150″ according to this embodiment is the same as that of the vibration type motor 150 according to the first embodiment, only differences from the first embodiment will be described in this embodiment.

Even in this embodiment, the shaft 113 is rotatably supported by the shaft receiver 106a of the movable sheet metal 106. However, as illustrated in FIGS. 8B and 9C, the shaft receiver 106a is formed in a V shape, and thereby the position of the shaft 113 is determined in the X direction relative to the movable sheet metal 106. Since the V-shaped shaft receiver 106a receives the cylindrical portion of the shaft 113 at two points, the surface pressure increases between the shaft 113 and the shaft receiver 106a, and only the rotating member (rotator of the bearing) 112 can smoothly rotate while the shaft 113 does not move when the movable part moves in the X direction.

As illustrated in FIGS. 8A and 9A, the diameter of the connector 113b of the shaft 113 that connects an engagement portion 113a with which the rotating member 112 is engaged is smaller than the diameter of the engagement portion 113a. Thereby, even if the diameter of the engagement portion 113a is large, the rolling surface 107a of the fixed metal plate 107 on which the rotating member 112 rolls can be disposed within a range of the thickness of the friction member 103 in the Z direction as illustrated in FIG. 9A. This structure can make the vibration type motor 150″ thinner in the Z direction than that where the rolling surface 107a is disposed outside the range of the thickness of the friction member 103.

The fixed sheet metal 107 is disposed between the movable sheet metal 106 and the pressure plate 108 in the Z direction. Since the rolling surface 107a of the fixed sheet metal 107 extends in the X direction, the pressing member 109 is disposed outside the fixed sheet metal 107 in the Y direction as illustrated in FIG. 9B. As illustrated in this figure, the pressing force F₁ of the pressing member 109 that presses the vibrator 100 against the friction member 103 is applied to the two rotating members 112 via the fixed sheet metal 107 (rolling surface 107a). The reaction force F₂ of the applied pressure is applied to the shaft receiver 106a via the movable metal plate 106. The pressing force F₁ and the pressing reaction force F2 are applied to the shaft 113 via the rotating member 112 and the shaft receiver 106a, and act to deform the shaft 113.

Thus, in this embodiment, a distance between the rotating member 112 and the shaft receiver 106a is shorter than that between the two rotating members 112 in the Y direction. Thereby, the point of action of the pressing force F₁ and the point of action of the pressing reaction force F₂ become closer to each other, and the shaft 113 can be prevented from deforming due to the pressing force F₁ and the pressing reaction force F₂.

In the description of the second embodiment, the two rotating members 112 are arranged side by side in the Y direction, but three or more rotating members 112 may be provided as long as they can move integrally with the movable sheet metal 106. For example, when three rotating members 112 are provided, the postures of the movable sheet metal 106 and the fixed sheet metal 107 are determined by the three rotating members 112, so that the movable part can be driven in a stable posture.

In the description of the second embodiment, the contact surfaces of the rotating member 112 and the rolling surface 107a are flat but for example, the contact surface of the rotating member 112 may be a curved surface and the rolling surface 107a may be a V-shaped bent surface. For example, if the two contact surfaces of the three rotating members 112 are curved surfaces and the rolling surface 107a is a V-shaped bent surface, the movable sheet metal 106 can move in the X direction while being linearly guided relative to the fixed sheet metal 107.

In the description of each of the above embodiments, the movable part holds the vibrator and the fixed part holds the friction member, but the movable part may hold the friction member and the fixed part may hold the vibrator. In other words, the movable part may hold one of the vibrator and the friction member, and the fixed part may hold the other.

In the description of each of the above embodiments, the lens holding member as the driven member is driven, but the configuration described in each of the above embodiments is applicable to a case where a driven member other than the lens holding member is driven.

The above embodiment can increase the moving length of the movable part without increasing the size of the movable part, and can prevent the vibration type driving apparatus from becoming larger caused by the larger movable part.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-195834, filed on Oct. 29, 2019, which is hereby incorporated by reference herein in its entirety.

What is claimed is:

1. A driving apparatus comprising a vibrator, a friction member that compressively contacts the vibrator, a movable part that holds one of the vibrator and the friction member, and a fixed part that holds the other of the vibrator and the friction member, the movable part moving relative to the fixed part when the vibrator vibrates,
wherein where a first axial direction is a direction in which the movable part moves relative to the fixed part due to a vibration of the vibrator, a second axial direction is a direction in which the vibrator is pressed against the friction member, a third axial direction is a direction orthogonal to the first and second axial directions, a first rotating direction is a rotating direction around an axis extending in the first axial direction, and a second rotating direction is a rotating direction around an axis extending in the second axial direction, the movable part is attached to the fixed part so that the movable part is restricted from displacing in the second axial direction and from rotating in the first rotating direction, and the movable part is allowed to move in the first axial direction, to displace in the third axial direction, and to rotate in the second rotating direction, and
wherein the movable part is connected to a driven member movable in the first axial direction so that the movable part is allowed to displace in the second axial direction and to rotate in the first rotating direction, and restricted from displacing in the third axial direction and from rotating in the second rotating direction.

2. The driving apparatus according to claim 1, further comprising, between the movable part and the driven member:
one first restrictor configured to restrict a displacement in the first axial direction; and
two second restrictors configured to restrict a displacement in a third axial direction, and provided in the first axial direction.

3. The driving apparatus according to claim 1, wherein where a third rotating direction is a rotating direction around an axis extending in the third axis direction, the movable part is attached to the fixed part so that the movable part is allowed to rotate in the third rotation direction, and
wherein the movable part is connected to the driven member so that the movable part is rotated in the third rotating direction.

4. The driving apparatus according to claim 1, wherein the movable part includes a rotating member configured to move in the first axial direction integrally with the movable part while rolling in contact with the fixed part.

5. The driving apparatus according to claim 4, wherein at least two rotating members are arranged in the third axial direction.

6. A driving apparatus comprising a vibrator, a friction member that comes into pressure contact with the vibrator, a movable part that holds one of the vibrator and the friction member, and a fixed part that holds the other of the vibrator and the friction member, the movable part moving relative to the fixed part when the vibrator vibrates,
wherein where a first axial direction is a direction in which the movable part moves relative to the fixed part due to a vibration of the vibrator, a second axial direction is a direction in which the vibrator is pressed against the friction member, and a third axial direction is a direction orthogonal to the first and second axial directions, the movable part includes a rotating member that moves in the first axial direction integrally with the movable part while rolling in contact with the fixed part,
wherein there are at least two rotating members on both sides of the friction member in the third axial direction, and
wherein a contact surface of the fixed part which the rotating member contacts and rolls on is provided within a range in which the friction member is provided in the second axial direction.

7. The driving apparatus according to claim 6, further comprising a pressing member configured to press the vibrator against the friction member outside the rotating member in the third axial direction.

8. The driving apparatus according to claim 6, wherein the contact surface is a flat surface.

9. The driving apparatus according to claim 6, wherein the vibration type driving apparatus moves a driven member connected to the movable part in the first axial direction.

10. An optical apparatus comprising a vibrator, a friction member that compressively contacts the vibrator, a movable part that holds one of the vibrator and the friction member, and a fixed part that holds the other of the vibrator and the friction member, the movable part moving relative to the fixed part when the vibrator vibrates,
wherein where a first axial direction is a direction in which the movable part moves relative to the fixed part due to a vibration of the vibrator, a second axial direction is a direction in which the vibrator is pressed against the friction member, a third axial direction is a direction orthogonal to the first and second axial directions, a first rotating direction is a rotating direction around an axis extending in the first axial direction, and a second rotating direction is a rotating direction around an axis extending in the second axial direction, the movable part is attached to the fixed part so that the movable part is restricted from displacing in the second axial direction and from rotating in the first rotating direction, and the movable part is allowed to move in the first axial direction, to displace in the third axial direction, and to rotate in the second rotating direction,
wherein the movable part is connected to a driven member movable in the first axial direction so that the movable part is allowed to displace in the second axial direction and to rotate in the first rotating direction, and restricted from displacing in the third axial direction and from rotating in the second rotating direction.

11. The optical apparatus according to claim 10, wherein the driven member is a lens holding member configured to hold a lens and to move in an optical axis direction.
